(19) United States
(12) Patent Application Publication
(10) Pub. No.: US 2012/0133623 A1
(43) Pub. Date: May 31, 2012

(54) ELECTRONIC SHELF LABEL APPARATUS FOR SWITCHING IMAGES AND METHOD THEREOF

(75) Inventors: Gi Young BYUN, Incheon (KR); Ung Han MOON, Suwon (KR); Jung Hwan PARK, Busan (KR); Yong Bok LEE, Osan (KR); Chang Soo LIM, Seoul (KR); Chang Soo YANG, Seongnam (KR)

(73) Assignee: SAMSUNG ELECTRO-MECHANICS CO., LTD.

(21) Appl. No.: 13/042,734

(22) Filed: Mar. 8, 2011

(30) Foreign Application Priority Data
Nov. 29, 2010 (KR) 10-2010-0119781

(51) Int. Cl. G09G 5/00

(52) U.S. Cl. 345/207

(57) ABSTRACT

There is provided an electronic shelf label including an image display unit displaying a first image; a sensor unit detecting image switching signals; and a processor unit determining whether the image switching signals detected by the sensor unit are valid and switching the first image displayed on the image display unit to a second image when the image switching signals are valid, and a communication unit receiving a plurality of image data displayed on the image display unit. The processor unit determines that the image switching signals are valid when a detection duration time of the image switching signals is longer than a predetermined first threshold time. By this configuration, the electronic shelf label can switch a plurality of images and reduce the influence of disturbance to thereby prevent unnecessary image switching. Further, the electronic shelf label can provide product-related information for a manager or the like as well as for a purchaser.

### CROSS-REFERENCE TO RELATED APPLICATIONS

This application claims the priority of Korean Patent Application No. 10-2010-0119781 filed on Nov. 29, 2010, in the Korean Intellectual Property Office, the disclosure of which is incorporated herein by reference.

### BACKGROUND OF THE INVENTION

1. Field of the Invention

The present invention relates to an electronic shelf label (ESL) allowing for the switching of a plurality of images displaying product information.

2. Description of the Related Art

Recently, attempts to replace a paper label, displaying information such as the prices of displayed products, or the like, with an electronic tag using an electronic device in locations selling various kinds of merchandise, such as distribution markets, have been conducted. The electronic tag is variously called an electronic shelf label (ESL), an electronic price label (EPL), and an electronic information label (EIL), or the like, all of which are similar in terms of purpose and usage.

The existing electronic shelf label (ESL) includes a screen capable of displaying product information transmitted thereto from a database server by wireless communication.

However, the existing electronic shelf label cannot display a wide variety of product information due to a limited display space on a screen thereof, such that a purchaser can only passively acquire limited product information. In addition, the existing electronic shelf label can only display the product information for a purchaser but cannot display product inventory information or the like for a manager, such that the usage thereof is limited.

### SUMMARY OF THE INVENTION

An aspect of the present invention provides an electronic shelf label (ESL) capable of switching a plurality of images displaying product information and providing product-related information for a manager or the like.

According to an aspect of the present invention, there is provided an electronic shelf label including: an image display unit displaying a first image; a sensor unit detecting image switching signals; and a processor unit determining whether the image switching signals detected by the sensor unit are valid, wherein the processor unit switches the first image displayed on the image display unit to a second image when it is determined that the detected image switching signals are valid.

The processor unit may determine that the image switching signals are valid when a detection duration time of the image switching signals is longer than a predetermined first threshold time.

The processor unit may determine whether a predetermined second threshold time has elapsed after the first image is switched to the second image, and switch the second image displayed on the image display unit to the first image when the second threshold time has elapsed.

The electronic shelf label may further include a communication unit receiving a plurality of image data displayed on the image display unit.

The sensor unit may include a light receiving sensor sensing a change in luminosity and detecting the image switching signals.

According to another aspect of the present invention, there is provided an image switching method of an electronic shelf label, the method including: displaying a first image on an image display unit and waiting for a detecting of image switching signals; determining whether the image switching signals have been detected by a sensor unit; determining, by a processor unit, a validity of the image switching signals when it is determined that the image switching signals have been detected; and switching, by the processor unit, the first image displayed on the image display unit to a second image when it is determined that the image switching signals are valid.

The determining of the validity of the image switching signals may be performed by determining that the image switching signals are valid when a detection duration time of the image switching signals is longer than a predetermined first threshold time.

The method may further include determining whether a predetermined second threshold time has elapsed after the first image is switched to the second image, returning to the waiting of the detection of the image switch signals when it is determined that the second threshold time has elapsed.

The method may further include receiving, by a communication unit, a plurality of image data displayed on the image display unit.

The sensor unit may include a light receiving sensor sensing a change in luminosity and detecting the image switching signals.

The sensor unit may include a first sensor unit and a second sensor unit each exposed to the outside of the electronic shelf label.

The image switching signals may include a first image switching signal detected by the first sensor unit and a second image switching signal detected by the second sensor unit.

The processor unit may switch the first image to the second image when the first image switching signal is valid, and switch the first image to a third image when the second image switching signal is valid.

The first image may display basic product information; the second image may display detailed product information, and the third image may display inventory information.

Each of the first sensor unit and the second sensor unit may include a light receiving sensor sensing a change in luminosity and detecting the image switching signals.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1 and 2 are diagrams showing the configuration of an electronic shelf label according to an exemplary embodiment of the present invention;

FIG. 3 is an operation timing chart for explaining the relationship between a change in output signals from a sensor unit and a displayed image according to an exemplary embodiment of the present invention;

FIG. 4 is a flowchart showing an image switching method of an electronic shelf label according to an exemplary embodiment of the present invention; and

FIG. 5 is a state transition diagram for explaining the relationship between a sensing signal from a first sensor unit and a second sensor unit and an image switching according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Throughout the drawings, the same reference numerals will be used to designate the same or like components.

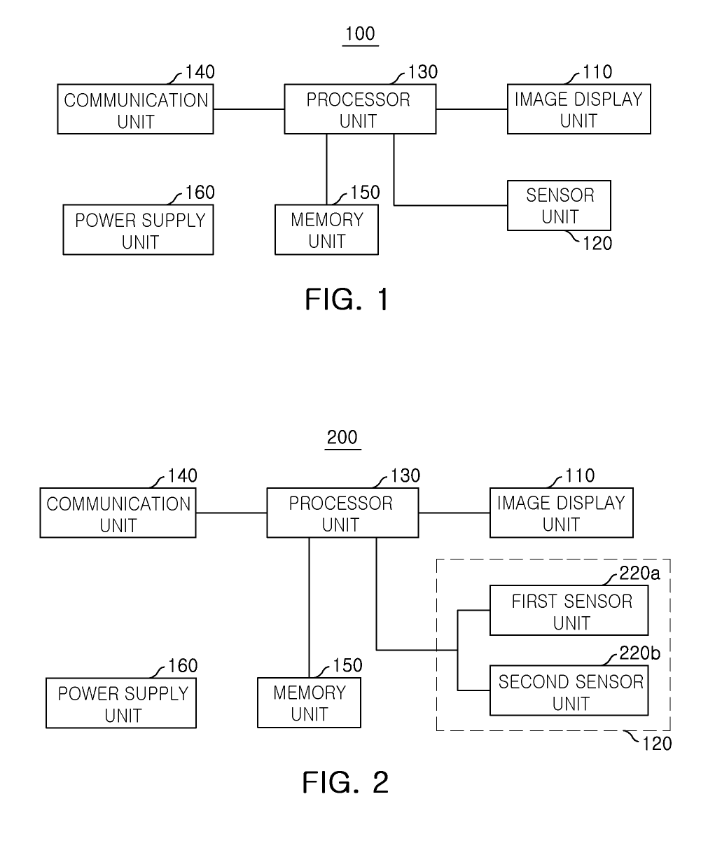

FIGS. 1 and 2 are diagrams showing the configuration of an electronic shelf label according to an exemplary embodiment of the present invention. The electronic shelf label may be configured to include an image display unit 110, a sensor unit 120, a processor unit 130, a communication unit 10, a memory unit 150, and a power supply unit 160.

Referring to FIGS. 1 and 2, the image display unit 110 is electrically connected to the processor unit 130, displays a first image as a basic image and displays one of a second image and a third image switched according to an image switching request from the processor unit 130. In a case in which a previous state image is the second image or the third image, the image display unit 110 displays the first image according to the image switching request from the processor unit 130. Specifically, the first image may show product price information; the second image may show detailed product information; and the third image may show inventory information. In addition, the image display unit 110 may be all possible kinds of media capable of displaying information, such as a 7-segment display, a dot matrix display, an electrophoresis display, and the like.

The sensor unit 120 is electrically connected to the processor unit 130 and senses an image switching signal. Specifically, the sensor unit 120 may include a first sensor unit 220a capable of sensing a first image switching signal and a second sensor unit 220b capable of sensing a second image switching signal, each of which is exposed to the outside of the electronic shelf label and is configured as a light receiving sensor in which the output is changed according to a change in luminosity. In addition, the image switching signal may be the first image switching signal for the detailed product information and the second image switching signal for the inventory information.

The processor unit 130 is electrically connected to the image display unit 110, the sensor unit 120, the communication unit 140, and the memory unit 150, and determines the validity of image switching signals detected by the sensor unit 120. Specifically, the processor unit 130 determines that image switching signals are valid when a detection duration time of the image switching signal is longer than a predetermined first threshold time. When it is determined that the image switching signals are valid, the first image displayed on the image display unit 110 is switched to the second image, while the image switching signals are invalid, the basic image is continuously displayed without switching images. In addition, after switching the first image to the second image, the processor unit 130 determines whether or not a predetermined second threshold time has elapsed. When the second threshold time has elapsed, the processor unit 130 switches the second image displayed on the image display unit 110 to the first image. In addition, in the case in which the image switching signals include the first image switching signal for the detailed product information and the second image switching signal for the inventory information, the processor unit 130 may switch the first image to the second image when only the first image switching signal is valid, and may switch the first image to the third image when only the second image switching signal is valid.

The communication unit 140 receives a plurality of image data that can be displayed on the image display unit 110 from a database server (not shown) including image data through wireless communications. Specifically, the communication unit 140 may use at least one of various communication schemes, such as ZigBee, RFID, IR, RF, or the like.

The memory unit 150 may store the plurality of image data received by the communication unit 140 and may store the image data that can be displayed on the image display unit 110.

The power supply unit 160 is electrically connected to each unit of the electronic shelf label to supply power. The power supply unit 160 may be configured as an internal power supply device independent from the outside, i.e., a battery or the like, in consideration of the characteristics of the electronic shelf label.

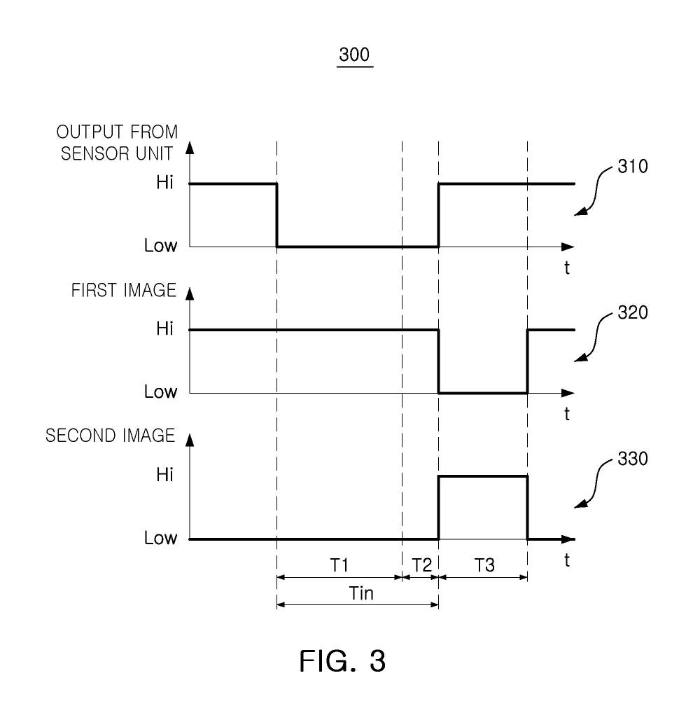

FIG. 3 is an operation timing chart for explaining the relationship between output from a sensor unit and image switching according to an exemplary embodiment of the present invention. A first operation timing chart 310 indicates the relationship between the output from the sensor unit 120 and a time; a second operation timing chart 320 indicates a time when the first image is displayed on the image display unit 110; and a third operation timing chart 330 indicates a time when the second image is displayed on the image display unit 110. In particular, FIG. 3 shows a process of determining whether the image switching signal detected in the electronic shelf label according to the exemplary embodiment of the present invention is valid, and a detailed description thereof will be described below.

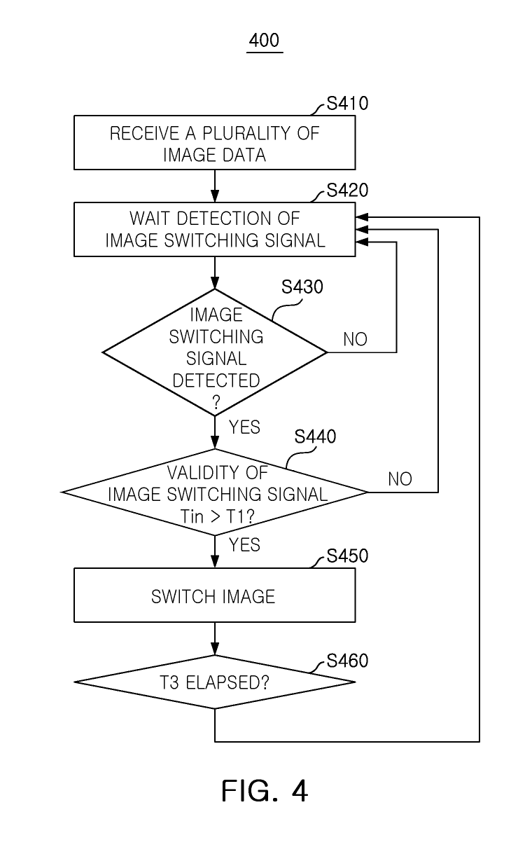

FIG. 4 is a flowchart showing an image switching method of an electronic shelf label according to an exemplary embodiment of the present invention. Referring to FIG. 4, the image switching method of the electronic shelf label according to the exemplary embodiment of the present invention may be applied to the electronic shelf label of FIG. 1.

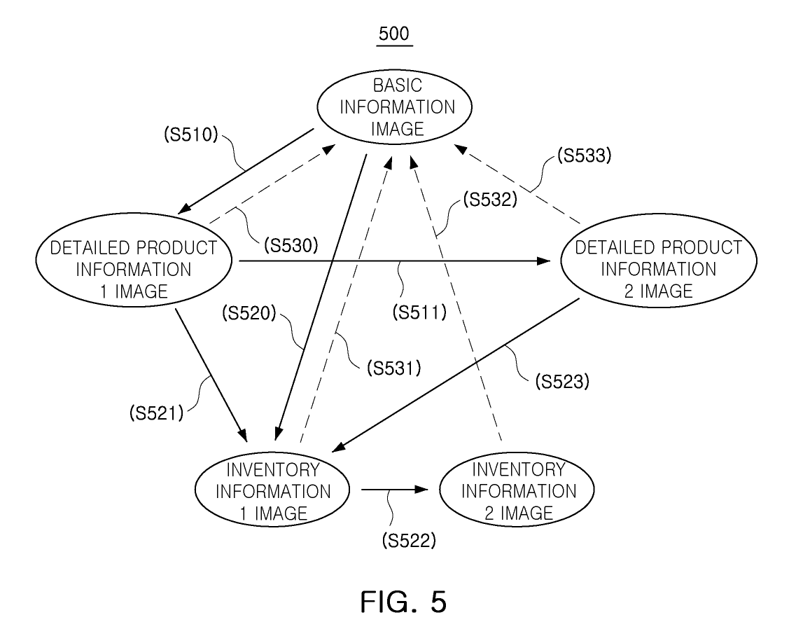

FIG. 5 is a state transition diagram for explaining the relationship of image switching among a basic information image, a detailed product information 1 image, a detailed product information 2 image, an inventory information 1 image, and an inventory information 2 image according to the first image switching signal and the second image switching signal respectively detected by the first sensor unit and the second sensor unit according to the exemplary embodiment of the present invention.

Hereinafter, the operations and effects of the present invention will be described in detail with reference to the accompanying drawings.

The electronic shelf label according to the exemplary embodiment of the present invention will be described with reference to FIG. 1. The electronic shelf label according to the exemplary embodiment of the present invention may include the image display unit 110 displaying a first image as a basic image, the sensor unit 120 capable of detecting image switching signals, the processor unit 130 determining whether the image switching signals detected by the sensor unit 120 are valid and switching the first image displayed on the image display unit 110 to a second image when it is determined that the image switching signals are valid, and the communication unit 140 receiving a plurality of image data displayed on the image display unit 110. The validity determination in the processor unit 130 is performed by determining that the image switching signals are valid when a detection duration time of the image switching signal is longer than a predetermined first threshold time. In addition, the processor unit 130 determines whether or not a second threshold time has elapsed upon displaying the second image. After the second image is displayed on the image display unit 110, when the second threshold time has elapsed, the processor unit 130 switches the second image to the first image. In addition, the sensor unit 120 according to the exemplary embodiment of the present invention may include a light receiving sensor in which output is changed according to a change in luminosity at the outside of the electronic shelf label. The light receiving sensor is a non-contact type, which can reduce a damage to the electronic shelf label as compared to a mechanical switch and lower the manufacturing costs of the electronic shelf label due to the low price.

A detailed description of an image switching operation and the validity of image switching signals determined by a processor unit in an electronic shelf label according to an exemplary embodiment of the present invention will be described with reference to FIG. 3. Hereinafter, the sensor unit 120 will be described as a light receiving sensor according to the exemplary embodiment of the present invention. The image display unit 110 displays a first image displaying a first product price information. That is, since no signal is sensed in the outside, the output from the light receiving sensor is indicated as high HI and the first image is continuously displayed on the image display unit 110. When the image switching signal is detected by the light receiving sensor, the output from the light receiving sensor falls to low LOW and a first threshold time T1 starts, but image switching is not immediately performed on the image display unit 110. Here, the detection of the image switching signals may assume the case in which light incident on the light receiving sensor is covered by a purchaser's finger. When the output from the light receiving sensor falls from high HI to low LOW, the processor unit 130 determines the validity of the detected image switching signals. The processor unit 130 recognizes the image switching signals as being valid and performs image switching only in the case in which the time for which the light receiving sensor is touched by the purchaser's finger, i.e., a time Tin of detecting the image switching signals in the light receiving sensor is longer than the predetermined first threshold time T1. More specifically, since the time Tin, from the instant in which the purchaser's finger covers the light receiving sensor to the separation of the purchaser's finger, is longer than the first threshold time T1 in the first operation timing chart 310 of FIG. 3, the image switching signals are determined to be valid. After the image switching signals are determined to be valid, when the purchaser's finger is separated from the light receiving sensor, the output from the light receiving sensor is high HI and the first image, displaying product price information on the image display unit 110, is switched to the second image, displaying detailed product information such as shelf-life, country of origin, and the like. According to another exemplary embodiment, image switching may occur within the time period of a delayed time T2 after the first threshold time has elapsed. When disturbance is present, for example, when a fluorescent lamp is flickered or an insect covers the light receiving sensor, or the like, the detection duration time Tin of the image switching signals from the sensor unit is shorter than the first threshold time T1, such that it is not determined that the image switching signals are valid and the image switching does not occur. Therefore, the influence of the disturbance is remarkably reduced due to the process of determining the validity of the image switching signals. Therefore, since unnecessary image switching does not occur, the reliability of the purchaser for the electronic shelf can be increased and power consumption can be reduced. After being switched to the second image, the processor unit 130 determines whether a predetermined second threshold time T3 has elapsed from the time when the first image is switched to the second image. When the second threshold time T3 has elapsed, the processor unit 130 switches the second image to the first image. That is, even if the purchaser does not make attempts to return the second image to the first image, the second image automatically returns to the first image, and thus the price indicating function that is a main usage of the electronic shelf label is faithfully performed.

The image switching method of the electronic shelf label according to an exemplary embodiment of the present invention will be described with reference to a flowchart of FIG. 4. A database server receives a plurality of image data in operation S410, which is made in the communication unit 140. However, operation S410 may be omitted in the case in which necessary image data has been stored in the memory unit 150 of the electronic shelf label and the renewal of the image data is unnecessary. A first image, which is a basic image displaying the product price information, or the like, is displayed on the image display unit 110 and the detection of the image switching signals by the sensor unit 120 is waited in operation S420. It is determined whether image switching signals have been detected by the sensor unit 120 based on output change from the sensor unit 120 in operation S430. It is determined whether the image switching signals detected by the sensor unit 120 are requested by the purchaser for image switching in operation S440. The validity determination is already described in detail with reference to FIG. 3, so the description thereof will be omitted. When the detected image switching signals are determined to be valid, the first image is switched to the second image in operation S450. After the switching to the second image, it is determined whether to return to the basic image in operation S460, depending on the determination of the processor unit 130 whether the second threshold time T3 has elapsed. When it is determined that the second threshold time T3 has elapsed, the process returns to operation S420.

Referring to FIGS. 2 and 5, the relationship between signals detected by the first sensor unit 220a and the second sensor unit 220b and image switching will be described according to an exemplary embodiment of the present invention. In FIG. 2, the sensor unit 120 includes the first sensor unit 220a and the second sensor unit 220b. For example, the first sensor unit 220a may be mounted at the top left of the electronic shelf label for a purchaser and the second sensor unit 220b may be mounted at the top right of the electronic shelf label for a manager. The first sensor unit 220a for the purchaser detects the first image switching signal according to the purchaser's intention that wants to switch a basic information image to a detailed product information image. The second sensor unit 220b for the manager detects the second image switching signal according to the manager's intention that wants to switch the basic information image or the detailed product information image to an inventory information image. The relationship between two sensor units 220a and 220b and image switching will be described with reference to FIG. 5. Here, a solid arrow indicates that a valid image switching signal is detected by one of the sensor units 220a and 220b, and a dotted arrow indicates that an image returns to a basic image after the image is switched. When the first image switching signal, which is valid in only the first sensor unit 220a, is detected, the processor unit 130 switches the basic information image, displaying basic information such as product price or the like, to a detailed product information 1 image (S510). When only the valid first image switching signal is detected before the second threshold time T3 has elapsed, the detailed product information 1 image is switched to a detailed product information 2 image (S511). When the second image switching signal, which is only valid in the second sensor unit 220b, is detected in the state in which the basic information image or the detailed product information 1 or 2 images is displayed, the displayed image is switched to an inventory information 1 image (S520, 5521, 5523). In the state in which one of the information images other than the basic information image is displayed and the image switching signal, which is valid in the first or second sensor unit 220a or 220b, is not detected, when the second threshold time T3 has elapsed, the processor unit 130 switches the displayed image to the basic information image (S530, S531, S532, S523). As shown in FIG. 5, since the electronic shelf label according to the exemplary embodiment of the present invention switches the plurality of information images using the plurality of valid image switching signals, it can provide product-related information for the purchaser, the manger, or the like, such that the electronic shelf label can be variously applied.

As set forth above, according to exemplary embodiments of the present invention, a plurality of images displaying product information may be switched according to a purchaser's intention to provide various kinds of product information to the purchaser. In particular, since an influence of disturbance may be reduced by determining the validity of image switching signals for image switching, unnecessary image switching can be avoided, and accordingly, consumer confusion may be prevented, power consumption may be reduced. Further, the electronic shelf label provides product-related information for a manager or the like as well as a purchaser, such that the electronic shelf label can be variously applied.

While the present invention has been shown and described in connection with the exemplary embodiments, it will be apparent to those skilled in the art that modification and variation can be made without departing from the spirit and scope of the invention as defined by the appended claims.

What is claimed is:

1. An electronic shelf label comprising:
an image display unit displaying a first image;
a sensor unit detecting image switching signals; and
a processor unit determining whether the image switching signals detected by the sensor unit are valid,
wherein the processor unit switches the first image displayed on the image display unit to a second image when it is determined that the detected image switching signals are valid.

2. The electronic shelf label of claim 1, wherein the processor unit determines that the image switching signals are valid when a detection duration time of the image switching signals is longer than a predetermined first threshold time.

3. The electronic shelf label of claim 1, wherein the processor unit determines whether a predetermined second threshold time has elapsed after the first image is switched to the second image, and switches the second image displayed on the image display unit to the first image when the second threshold time has elapsed.

4. The electronic shelf label of claim 1, further comprising a communication unit receiving a plurality of image data displayed on the image display unit.

5. The electronic shelf label of claim 1, wherein the sensor unit comprises a light receiving sensor sensing a change in luminosity and detecting the image switching signals.

6. The electronic shelf label of claim 1, wherein the sensor unit includes a first sensor unit and a second sensor unit each exposed to the outside of the electronic shelf label.

7. The electronic shelf label of claim 6, wherein the image switching signals include a first image switching signal detected by the first sensor unit and a second image switching signal detected by the second sensor unit.

8. The electronic shelf label of claim 7, wherein the processor unit switches the first image to the second image when the first image switching signal is valid, and switches the first image to a third image when the second image switching signal is valid.

9. The electronic shelf label of claim 8, wherein the first image displays basic product information,
the second image displays detailed product information, and
the third image displays inventory information.

10. The electronic shelf label of any one of claim 6, wherein each of the first sensor unit and the second sensor unit includes a light receiving sensor sensing a change in luminosity and detecting the image switching signals.

11. The electronic shelf label of any one of claim 7, wherein each of the first sensor unit and the second sensor unit includes a light receiving sensor sensing a change in luminosity and detecting the image switching signals.

12. An image switching method of an electronic shelf label, the method comprising:
displaying a first image on an image display unit and waiting for a detecting of image switching signals;
determining whether the image switching signals have been detected by a sensor unit;
determining, by a processor unit, a validity of the image switching signals when it is determined that the image switching signals have been detected; and
switching, by the processor unit, the first image displayed on the image display unit to a second image when it is determined that the image switching signals are valid.

13. The method of claim 12, wherein the determining of the validity of the image switching signals is performed by determining that the image switching signals are valid when a detection duration time of the image switching signals is longer than a predetermined first threshold time.

14. The method of claim 12, further comprising determining whether a predetermined second threshold time has elapsed after the first image is switched to the second image,
returning to the waiting of the detection of the image switch signals when it is determined that the second threshold time has elapsed.

15. The method of claim 12, further comprising receiving, by a communication unit, a plurality of image data displayed on the image display unit.

16. The method of claim 12, wherein the sensor unit includes a light receiving sensor sensing a change in luminosity and detecting the image switching signals.

17. The method of claim 12, wherein the sensor unit includes a first sensor unit and a second sensor unit each exposed to the outside of the electronic shelf label.

18. The method of claim 17, wherein the image switching signals include a first image switching signal detected by the first sensor unit and a second image switching signal detected by the second sensor unit.

19. The method of claim 18, wherein the processor unit switches the first image to the second image when the first image switching signal is valid, and switches the first image to a third image when the second image switching signal is valid.

20. The method of claim 19, wherein the first image displays basic product information,
the second image displays detailed product information, and
the third image displays inventory information.

21. The method of any one of claim 17, wherein each of the first sensor unit and the second sensor unit includes alight receiving sensor sensing a change in luminosity and detecting the image switching signals.

22. The method of any one of claim 18, wherein each of the first sensor unit and the second sensor unit includes alight receiving sensor sensing a change in luminosity and detecting the image switching signals.
